(19) United States
(12) Patent Application Publication
(10) Pub. No.: US 2010/0313480 A1
(43) Pub. Date: Dec. 16, 2010

(54) WINDOW WITH ELECTRICAL CONNECTION TO OPERABLE SASH

(76) Inventors: Réjean VERREAULT, Les Mechins (CA); Hugues ROULEAU, Saint-Redempteur (CA); Bertrand NADEAU, Saint-Etienne-de-Lauzon (CA); Pierre LAVOIE, Saint-Etienne-de-Lauzon (CA); Stéphane BENOIT, Saint-Edouard (CA)

Correspondence Address: OGILVY RENAULT LLP, 1, Place Ville Marie, SUITE 2500, MONTREAL, QC, H3B 1R1, CA

(21) Appl. No.: 12/813,014

(22) Filed: Jun. 10, 2010

Related U.S. Application Data
(60) Provisional application No. 61/185,927, filed on Jun. 10, 2009.

(51) Int. Cl. E05F 15/18; E05B 1/00

(52) U.S. Cl. 49/358

(57) ABSTRACT

The window has a sash mounted in a frame, the sash having an electrical system and being selectively operable into one of a closed state and an open state, a lock between the sash and the frame, the lock being selectively operable into one of a locked state and an unlocked state, an electrical connection connecting the frame and the electrical system of the sash, and a sensor-switch device which senses the open state and which causes the electrical connection to be open when the sash is in the open state

### CROSS-REFERENCE TO RELATED APPLICATIONS/PRIORITY CLAIM

This application claims priority of U.S. provisional application No. 61/185,927, filed Mar. 6, 2008, the contents of which are hereby incorporated by reference.

### FIELD

The specification relates principally to residential and commercial windows, and more particularly to windows which have an electrical connection between an electrical system in the operable sash and a frame.

### BACKGROUND

It is becoming more and more popular to provide window sashes having electrical systems. Such systems can include heating panes for instance. While providing electrical connections to fixed panes has been achieved in a relatively satisfactory manner, there are particular challenges to providing electrical connections to operable sashes. For instance, a heating pane on an open sash can represent a waste of electricity.

Further, using an electrical connector between an operable sash and a frame could result in a powered socket being exposed when the operable sash is opened, which is undesired, particularly at household voltages. Alternately, wired connection can be subjected to stress and fatigue upon successive operation of the sash and there is a challenge in providing a fatigue-resistant wired connection which remains visually appealing.

There thus remained room for improvement in providing electrical connections to operable sashes in windows such as sliding patio doors and casement windows.

### SUMMARY

In accordance with one aspect, there is provided a window having a sensor-switch device which automatically opens the electrical connection between the frame and the sash when the sash is in the open state. Henceforth, the electrical system automatically becomes inoperative, and/or if an electrical connector is used, any plug or socket which becomes exposed upon opening of the window are automatically de-energized prior to becoming exposed.

In accordance with a more specific aspect, in some embodiments, the sensor-switch device can be configured to close the electrical connection between the frame and the sash only when a lock between the sash and the frame is in a locked state, for greater certainty.

In accordance with one aspect, there is provided a window comprising a sash mounted in a frame, the sash having an electrical system and being selectively operable into one of a closed state and an open state, a lock between the sash and the frame, the lock being selectively operable into one of a locked state and an unlocked state, an electrical connection connecting the frame and the electrical system of the sash, and a sensor-switch device which senses the open state and which causes the electrical connection to be open when the sash is in the open state.

In accordance with another aspect, there is provided an electrified window comprising: a window frame provided with electricity; at least one operable sash having a pane, said operable sash being adapted to move, within said window frame, said operable sash has an opening side, said opening side corresponding to a side of operable sash which separates from said frame when said operable sash is in said open position, said operable sash being adapted to move between a closed position in which said opening side is adjacent to said frame and no air can travel through the junction and an open position in which air can circulate from one side of the window to an other side through an opening created by a displacement of said opening side away from said frame; an electrically powered system for said window adapted to be powered on by electricity and adapted to produce a change in a condition of said window upon powering on by electricity; an electrical connector connecting said operable sash to said frame for allowing said electricity to electrify said electrically powered system when said sash is in said closed position and for being disconnected upon displacement of said operable sash to said open position.

In this specification, the word “window” is intended to include any type of window product, including casement windows, single hung and double hung windows, sliding windows (single or double sliders), bay windows, bow windows, skylights, awning windows, patio doors (slider doors, sliding glass doors or window doors), etc.

### DESCRIPTION OF THE FIGURES

FIG. 1 is an oblique view of a first embodiment of a window, the window being a patio door in this case;

FIG. 2 is an oblique view, enlarged and fragmented, of the lock of the patio door;

FIGS. 3A and 3B show the lock in the unlocked and locked states, respectively;

FIG. 4 is an oblique view, enlarged and fragmented, showing an electrical connector of the patio door;

FIG. 5 is a schematic showing the electrical connection of the patio door;

FIG. 6 is an oblique view of a second embodiment of a window, the window being a casement window in this case;

FIGS. 7A to 7C are cross-sectional views showing the casement window in the open, closed, and locked state, respectively;

FIG. 8 is an other oblique view, enlarged and fragmented, of the casement window;

FIG. 9 is a schematic showing the electrical connection of the casement window;

FIG. 10 is an oblique view showing a variant of a casement window.

### DETAILED DESCRIPTION

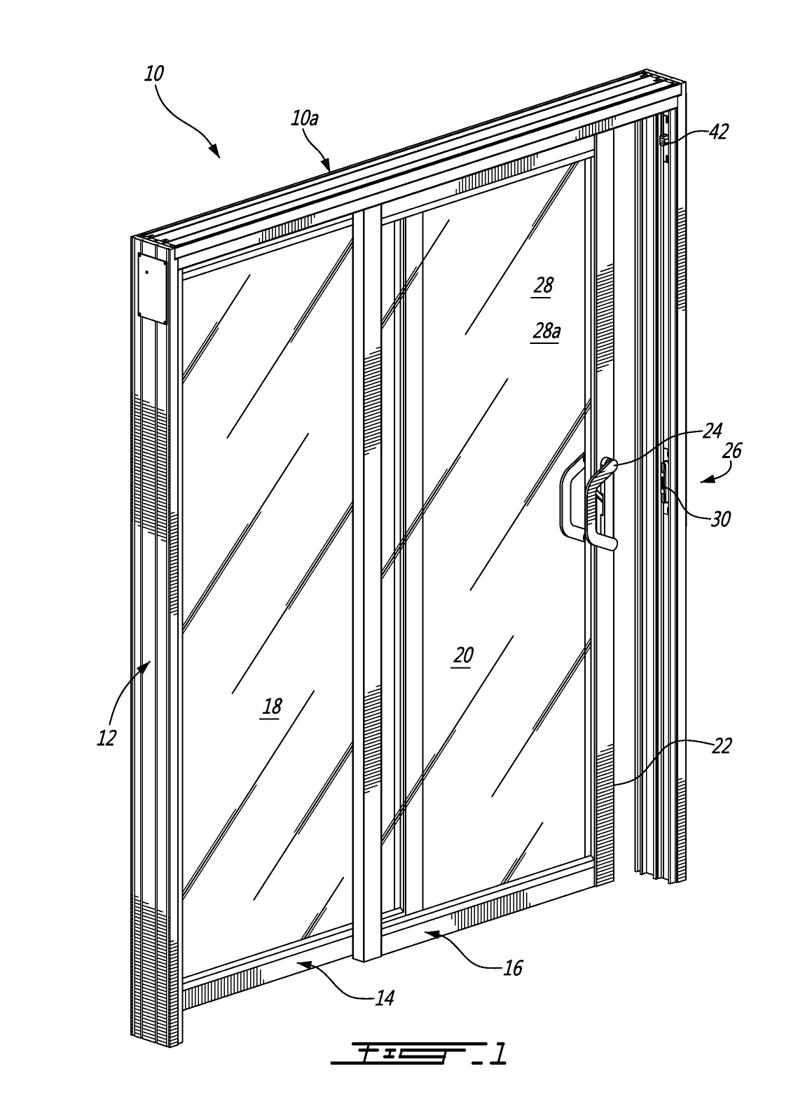

FIG. 1 shows an example of a window 10. In this case, the window 10 is in the form of a patio door 10a which has similarities to a large sliding window. The patio door 10a has a frame 12 and two sashes 14, 16. Typically, only one 16 of the two sashes is operable while the other sash 14 is fixed. In this case, both sashes 14, 16 have a window pane 18, 20. The operable sash 16 is slidingly mounted in the frame 12 along upper and lower rails and has an opening side 22 which is placed into abutting contact with the frame 12 when in the closed state. The operable sash 16 can be slid open from the closed state by using a handle 24 affixed to the opening side 22. The patio door 10a has a lock 26 which can be operated from the inside to lock the operable sash 16 in the closed state and prevent undesired intrusion from the outside.

The operable sash 16 has an electrical system 28 which requires it to be electrically connected to the frame 12. The electrical system 28 in this embodiment is a heating window pane 28a. In alternate embodiments, the electrical system 28 can be another electrically powered system such as an automatically shading window pane or a ventilation system, for example, or can be a generator such as a solar panel pane for instance, or a sensor to detect luminosity or temperature, for instance, to name a few examples. There can be more than one electrical system in the sash. As will be seen below, in this example, the other sash, or fixed sash, also has a heating window pane in this embodiment, although in alternate embodiments, the other sash can have different electrical system(s) or no electrical system, for instance.

The illustrated patio door 10a is provided with a sensor-switch device 30 for opening the electrical connection to disable the electrical system 28 when the sash 16 is in the open state shown in FIG. 1. Further, it will be seen below that the sensor-switch device 34 provides even further certainty by providing for closing the electrical connection not just when the sash 16 is in the closed state, but only when the lock 26 is engaged.

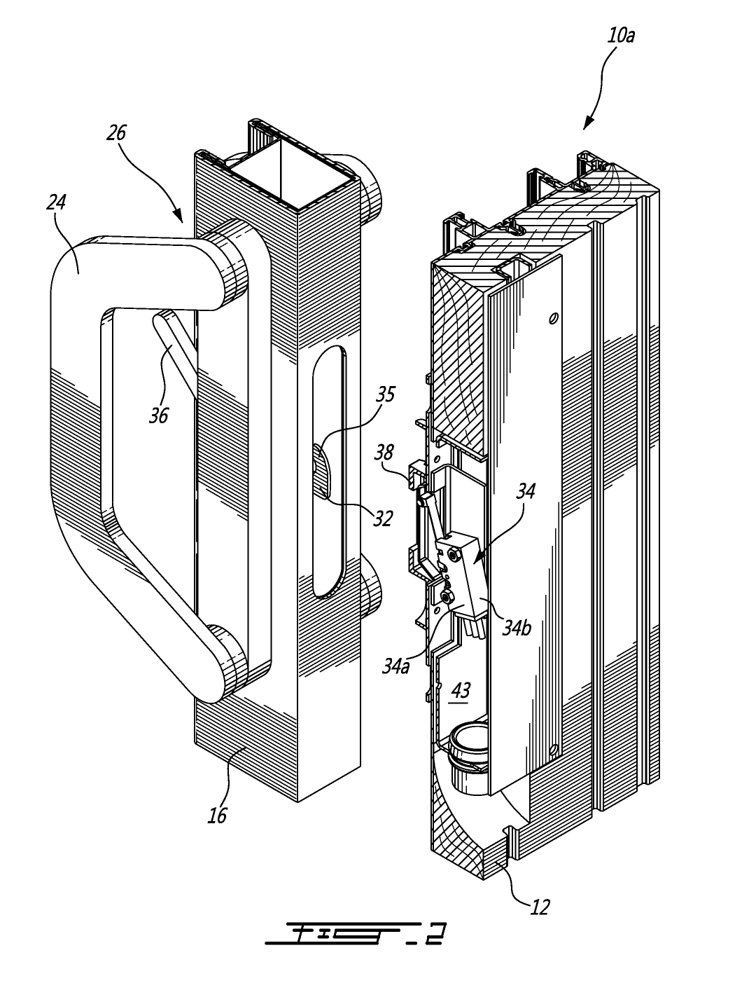

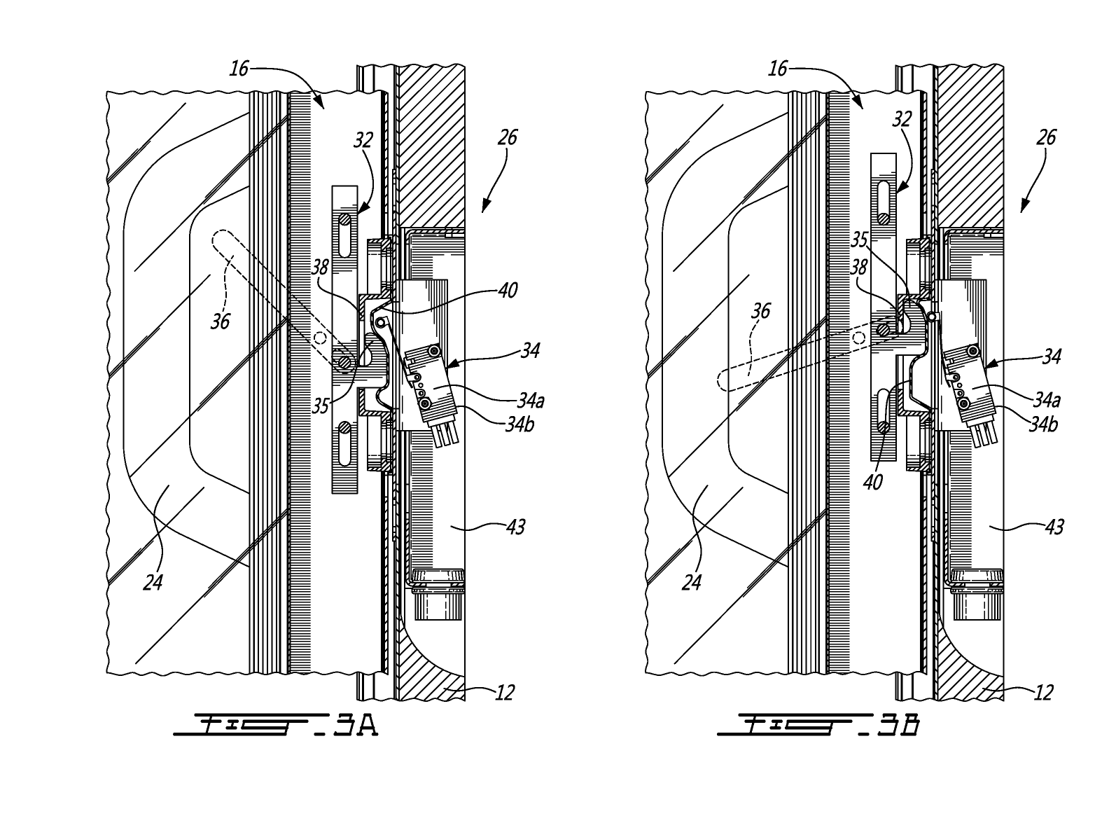

The particular sensor-switch device 34 used in this patio door 10a is depicted in detail in FIG. 2. More particularly, the lock 26 of the patio door 10a can be seen to include a latch 32 provided on the sash 16 and having a latch hook 35 activatable by a lever 36 in this case. The lock 26 further includes a keeper 38 provided on the frame 12, and aligned with the latch hook 35. The sensor-switch device 34 in this case includes a mechanical lever proximity switch 34a which is positioned inside the keeper 38 specifically to become engaged by the latch hook 35 when the lock 26 is in the locked state with the latch hook 35 engaged with the keeper 38 (shown in FIG. 3B). The proximity switch 34a default is to open the electrical connection which leads to the electrical system in the sash 16. However, when the proximity switch 34a is activated by the latch hook 35, the action of which is shown from FIG. 3A to FIG. 3B, it closes the electrical connection which leads to the electrical system in the sash for providing power to it.

In this particular embodiment, the proximity switch 34a is covered by a rubber cover 40 which protects it from intrusion of water through the opening of the keeper 38 when the sash 16 is in the open state. It will be understood here that the proximity switch 34a acts as a sash position detector 34b in the sense that it can be considered to sense that the sash 16 is in the open state because it maintains the electrical connection open by default and the latch hook 35 cannot engage it when the sash 16 is open. Otherwise put, this configuration further provides the certainty that not only the sash 16 must be in the closed state, but the lock 26 must further be in the locked state, for the electrical connection to become closed. In this embodiment, the proximity switch 34a is enclosed in an electrical box 43.

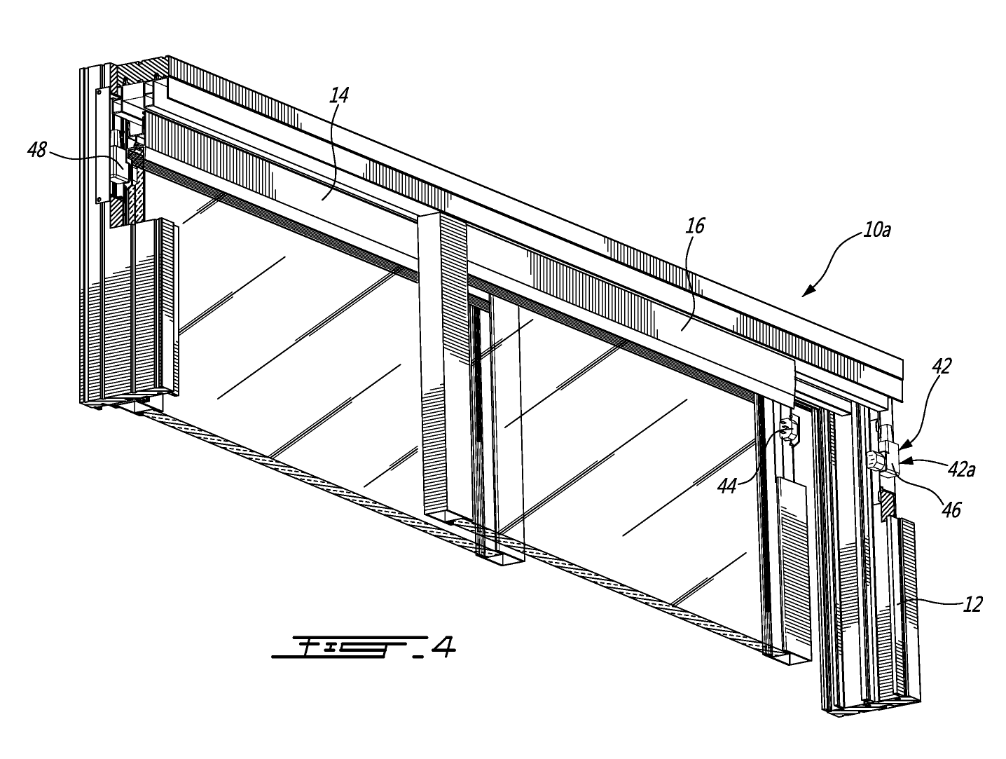

Turning now to FIG. 4, the electrical connection between the frame and the sash 16 in this embodiment can be seen to include an electrical connector 42. The electrical connector 42 is positioned in the upper portion of the patio door 10a to keep it substantially out of reach. In the illustrated example, the electrical connector 42 is a plug and socket connector 42a with the plug 44 and socket 46 being aligned in the direction of displacement of the sash 16 in a manner that they become engaged automatically when the sash 16 is closed. Although as seen above, the electrical connector 42 is not powered when the sash 16 is open due to the sensor-switch device (34, FIGS. 2-4), and that it is further substantially out of reach, it can be preferred to position the socket 46 on the frame 12 and the plug 44 on the sash 16 given the fact that the socket 46 is a female connector, it provides even more safety due to the fact that its electrical components are unexposed.

In this particular embodiment, for reasons of simplicity of design and installation, the fixed sash 14 is also provided with an identical electrical connector 48 (or temporary connection) even though it normally remains fixed.

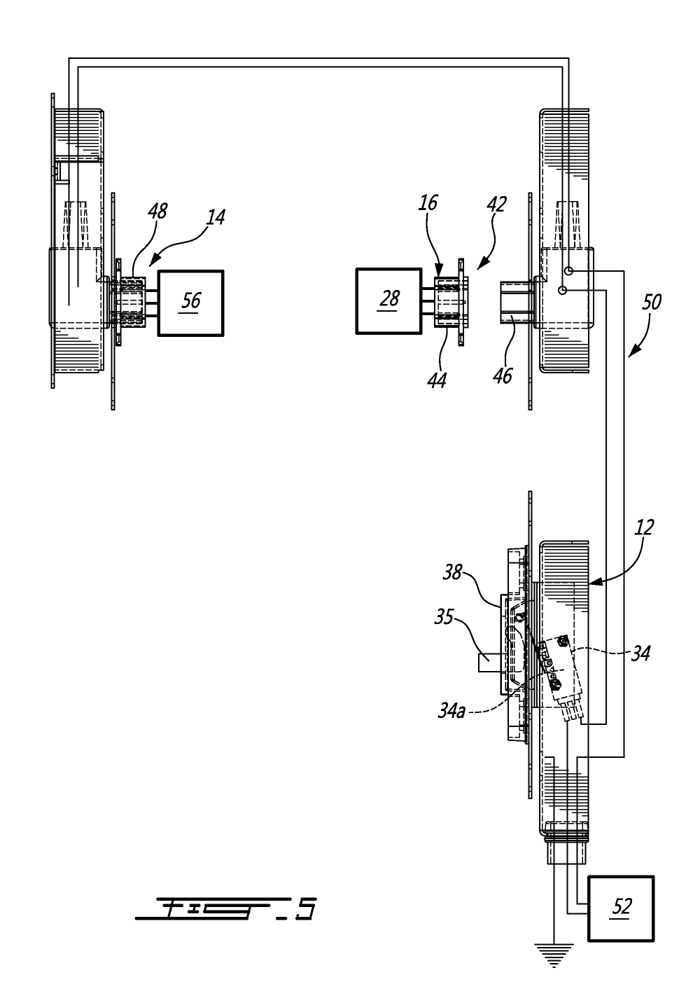

The electrical connection 50 between the frame 12 and the sash 16 is schematically depicted in FIG. 5, where the proximity switch 34a can be seen to be connected to a power source 52 in the frame and be activatable to close the electrical connection 50 leading from the power source 52 to the socket 46 of the electrical connector 42 leading to the electrical system 28 of the operable sash 16. Further, an optional connection to an other electrical system 56 of an other sash 14 is also shown for illustrative purposes.

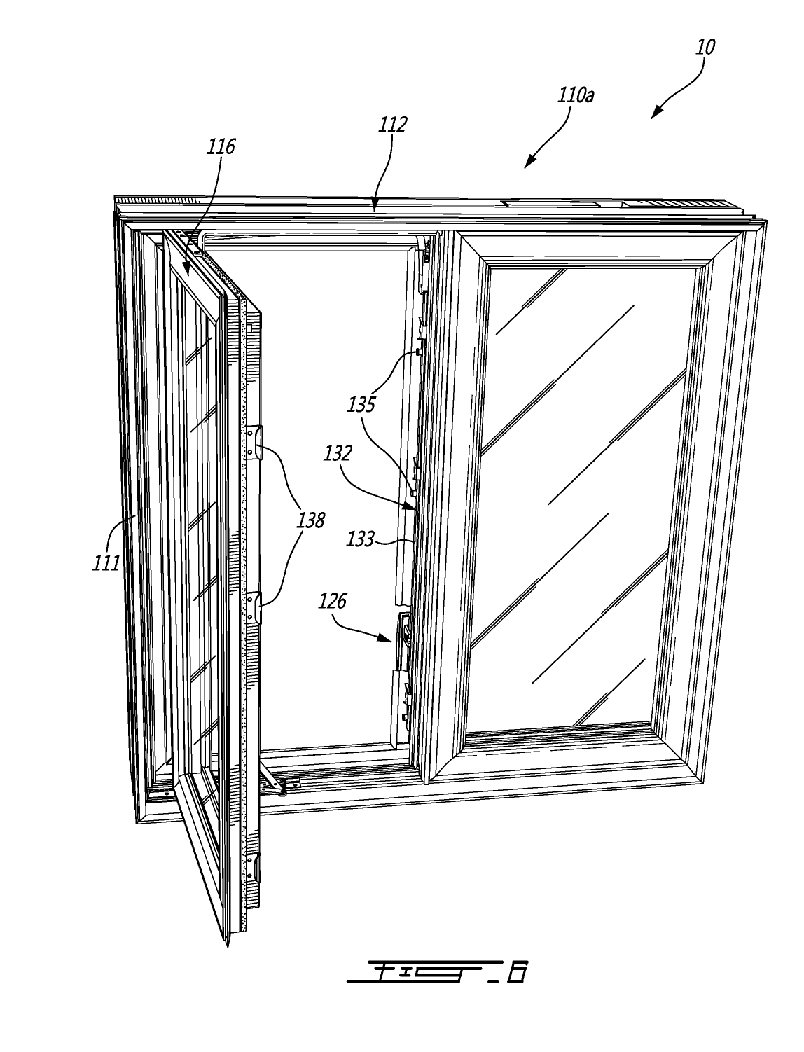

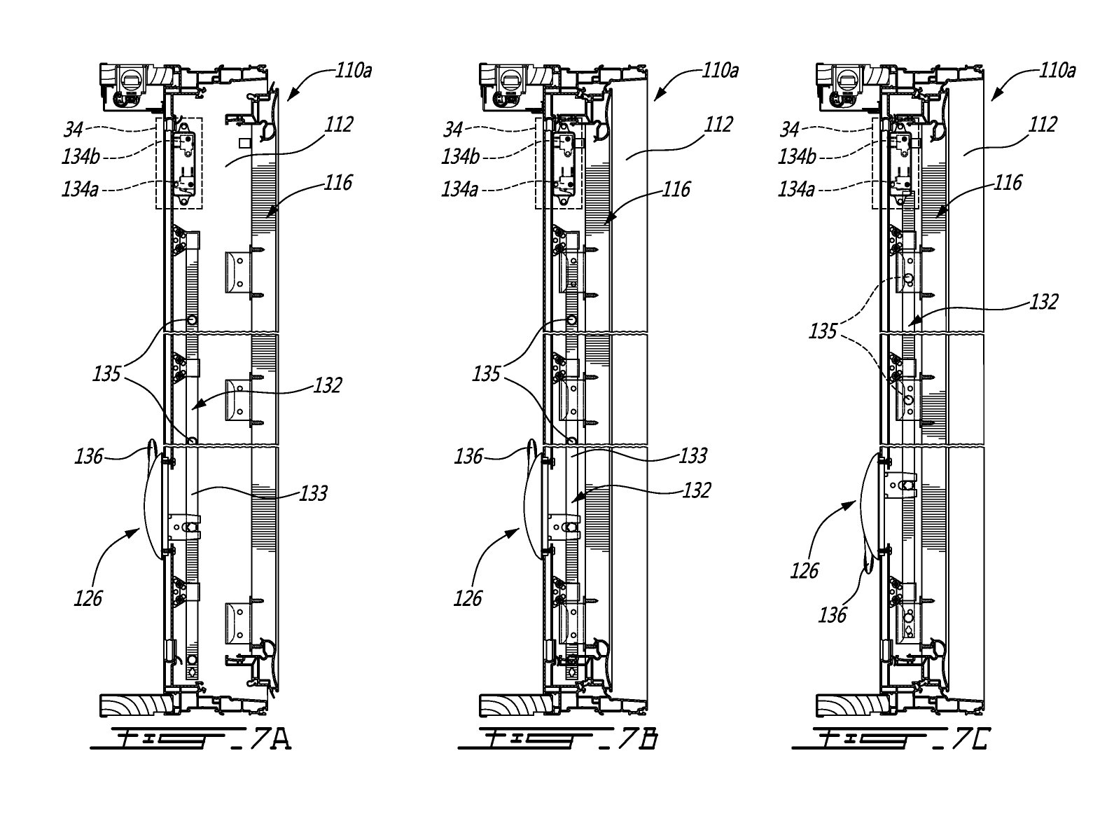

Turning now to FIG. 6, an other example of a window 10 is shown. In this case, the window 10 is in the form of a casement window 110a where an operable sash 116 is pivotally mounted along a side 111 of the frame 112. The operable sash 116 can be manually operated to move between a closed state and an open state by actuating a crank (not shown) located inside. Once the sash 116 is placed in the closed state, a lock 126 can be activated by a lever (136-FIGS. 7A-7C) located inside. The lever 136 activates a latch 132 by moving a latch rod 133 slidingly engaged with the frame 112 upwardly. The latch rod 133 has a number of latch hooks 135 in the form of pins having a wide head, and the heads of these pins are moved into engagement with corresponding keepers 138 positioned on the sash 116 as the latch rod 133 is moved upwardly.

The action of closing and locking the casement window 110a is illustrated in the successive views of FIGS. 7A to 7C.

The sensor-switch device 34 used in this embodiment differs from the one described above in relation with the patio door 10a. In this embodiment, the sensor-switch device 34 includes two proximity switches: a first proximity switch 134b positioned on the frame 112 in a manner to become activated to close the electrical connection when the sash 116 is in the closed state, and a second proximity switch 134a positioned on the frame 112 and aligned with the latch rod 133 to become activated by the latch 132 when it is placed in the locked state. In embodiments where the first proximity switch 134b is used, the second proximity switch 134a can be omitted, but it is nonetheless used here because it provides further certainty. The second proximity switch 134a is thus optional. The default position of both proximity switches 134a, 134b is to open the electrical connection unless specifically activated. It will be understood that although both proximity switches 134a 134b are positioned here adjacent to each other and in a common electrical box, they can be positioned elsewhere and/or at different locations in alternate embodiments.

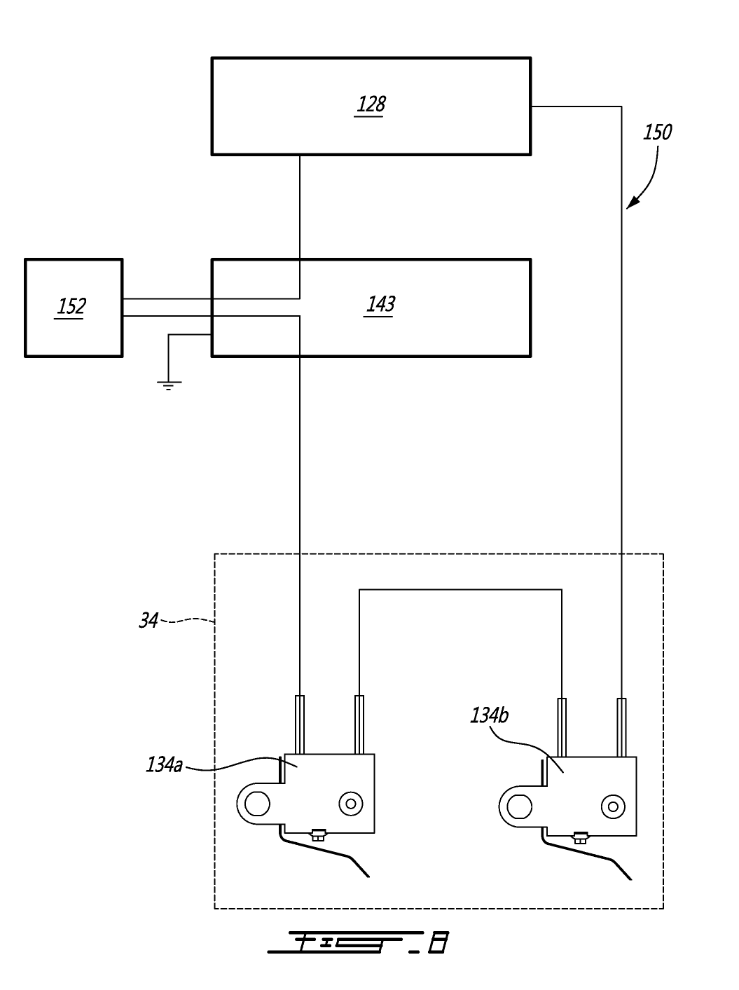

In the case of the casement window 110a, the use of two distinct proximity switches 134a, 134b allows to achieve a function equivalent to the locking detection offered by the sensor-switch device 34 described above in relation with the patio door 110a. The reason for this is that because in the case of the casement window 110a the latch 132 is provided on the frame 112 rather than the sash 116, it is possible to activate the latch 132 into engagement with the proximity switch 134a even though the sash 116 is not in the closed state. The presence of the first proximity switch 134b, or sash position detector, confirms that the sash 116 is in the closed state when the latch 132 is engaged and that the electrical connection can be closed to power the electrical system 128 in the sash 116. This is schematically described in the schematic view provided in FIG. 8 which further shows an electrical box 143 and a power source 152.

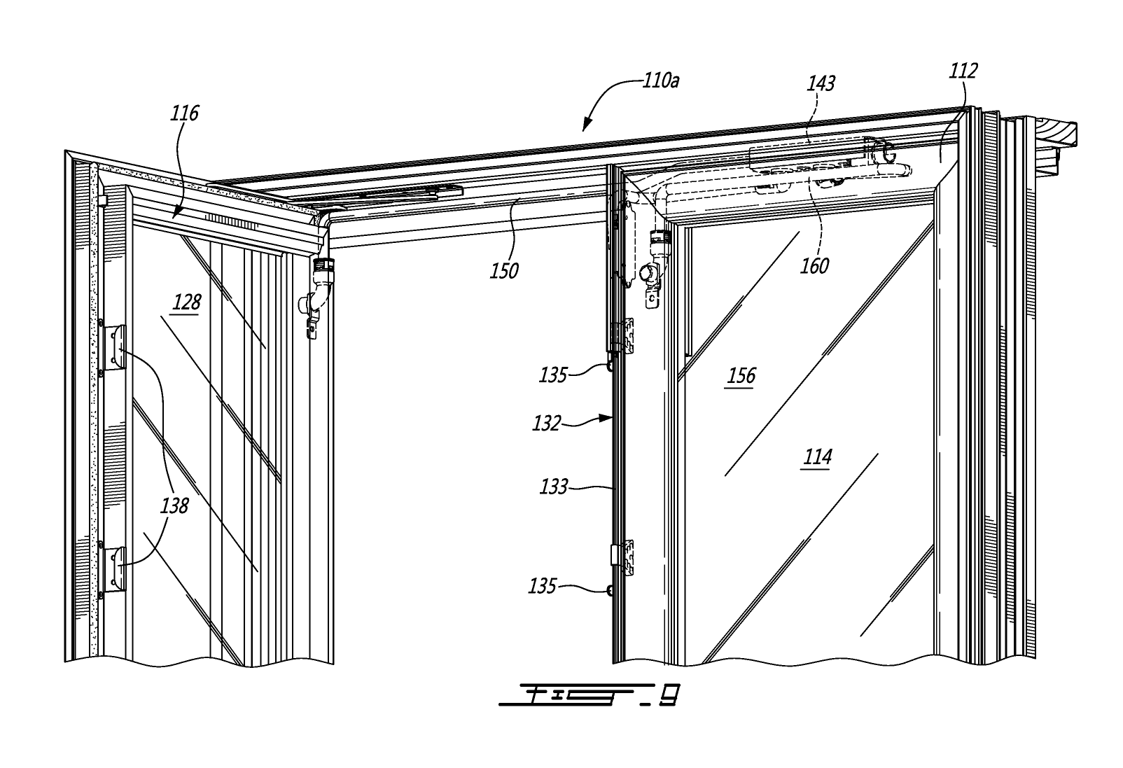

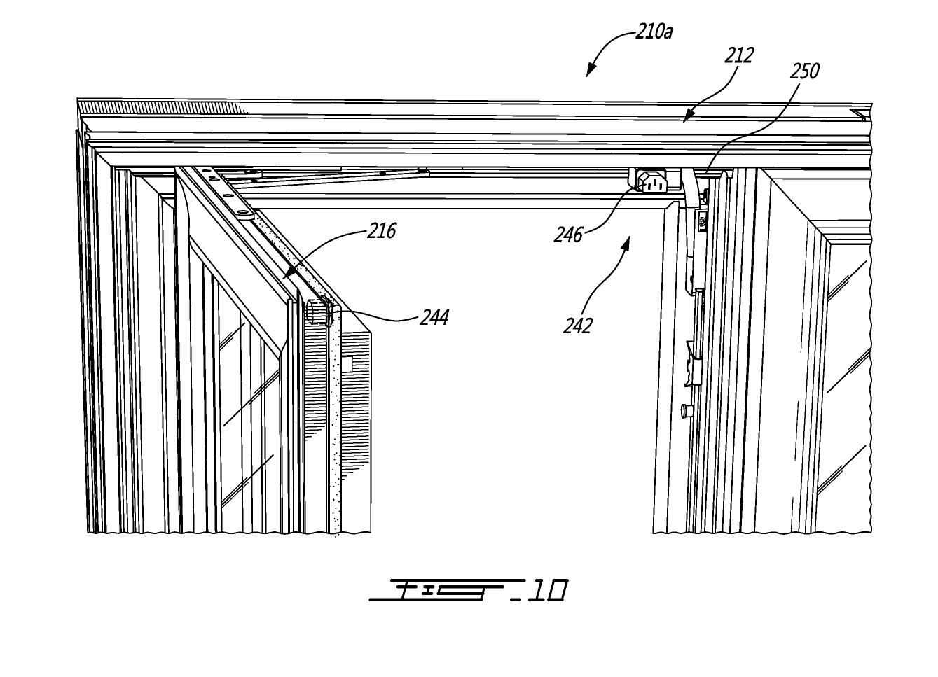

Turning to FIG. 9, it can be seen that in this specific embodiment, the electrical connection 150 between the frame 112 and the electrical system 128 in the sash 116 is permanent and wired. It can further be noted that another electrical connection 160 provides electricity to an electrical system 156 of an other sash 114 (which can be fixed or operable, for instance), which is optional. Alternately, as shown in FIG. 10, an other embodiment of a casement window 210a can have an electrical connection 250 between the frame 212 and the electrical system in the sash 216 can be temporary and provided by an electrical connector 242 such as a plug 244 and socket 246 connector for instance.

It will be understood that many variants are possible to the embodiments described above and illustrated herein. For instance, the sensor-switch device can be applied to other windows having operable sashes than casement windows and patio doors. Such alternate windows can have one, two, or three sashes, with at least one thereof, and optionally two or more, being operable and having at least one electrical system.

Further, although the sensor-switch devices described above included proximity switches, equivalent or comparable results can be achieved using other means. For instance, a sensor can be provided separately from a switch device, like a sensor which sends a signal to a controller where the controller acts like a switch and closes the electrical connection. If used, different proximity switches than those illustrated can be used, contact or contactless, such as infrared, acoustic, optical, capacitive, or inductive, for instance.

It will be understood that the use of an electrical connector is optional. However, if used, it can be other than a plug and socket or quick connect connector. For instance, the connector can be contactless, such as capacitive, inductive, or radio-frequency connector providing an exchange of electricity between the frame and the sash when in the connection configuration, and the electrical connector can be a bi-directional connector to allow energy generated for example by a solar panel to be transferred to the frame via the electrical connector for instance.

Other electrical systems than the ones identified above can be used in alternate embodiments. Typically, an electrically powered system produces a change in a condition of the window upon powering on by electricity. In the case of a heating window pane, the change in condition of the window can be a change in temperature of the glass, for instance. In all cases, due to the likelihood of the conditions of use, it will be preferred that the connector be resistant to water.

As can be seen therefore, the examples described above and illustrated are intended to be exemplary only. The scope is indicated by the appended claims.

What is claimed is:

1. A window comprising a sash mounted in a frame, the sash having an electrical system and being selectively operable into one of a closed state and an open state, a lock between the sash and the frame, the lock being selectively operable into one of a locked state and an unlocked state, an electrical connection connecting the frame and the electrical system of the sash, and a sensor-switch device which senses the open state and which causes the electrical connection to be open when the sash is in the open state.

2. The window of claim 1 wherein the lock has a latch as part of the sash, and a keeper as part of the frame, wherein the sensor-switch device detects the locked state when the latch is engaged with the keeper and closes the electrical connection upon said detection.

3. The window of claim 2 wherein the sensor-switch device has a proximity switch positioned in the frame to detect the presence of the latch when engaged with the keeper.

4. The window of claim 2 wherein the sash is slidingly mounted to the frame and the window is a sliding patio door.

5. The window of claim 1 wherein the lock has a latch as part of the frame and a keeper as part of the sash, wherein the sensor-switch device detects both the state of the lock and the state of the sash, and opens the electrical connection when either one of the unlocked state and the open state are detected.

6. The window of claim 5 wherein the sensor-switch device has a first proximity switch positioned in the frame to sense the presence of the latch when in the locked position, and a second proximity switch positioned in the frame to sense the presence of the sash when in the closed state.

7. The window of claim 5 wherein the sash is pivotally mounted to the frame and the window is a casement window.

8. The window of claim 7 wherein the electrical connection has a wired connection between the sash and the frame.

9. The window of claim 1 wherein the electrical connection includes an electrical connector connecting the sash to the frame when the sash is in the closed position, and being disconnected when the sash is not in the closed position.

10. The window of claim 9 wherein the electrical connector is a plug and socket connector.

11. The window of claim 10 wherein the socket is mounted to the frame and the plug is mounted to the sash.

12. The window of claim 1 wherein the electrical connection is connected to a power source on the frame.

13. The window of claim 1 further comprising an other sash.

14. An electrified window comprising:
a window frame provided with electricity;
at least one operable sash having a pane, said operable sash being adapted to move, within said window frame, said operable sash has an opening side, said opening side corresponding to a side of operable sash which separates from said frame when said operable sash is in said open position, said operable sash being adapted to move between a closed position in which said opening side is adjacent to said frame and no air can travel through the junction and an open position in which air can circulate from one side of the window to an other side through an opening created by a displacement of said opening side away from said frame;
an electrically powered system for said window adapted to be powered on by electricity and adapted to produce a change in a condition of said window upon powering on by electricity;
an electrical connector connecting said operable sash to said frame for allowing said electricity to electrify said electrically powered system when said sash is in said closed position and for being disconnected upon displacement of said operable sash to said open position.

15. The electrified window as claimed in claim 14, further comprising a handle for said operable sash, said handle being adapted to allow control of movement of said operable sash between said closed position and said open position, said handle being provided on said opening side.

16. The electrified window as claimed in claim 15, further comprising a lock for said operable sash, said lock being provided on said handle, said lock comprising a lever-type handle connected to a latch hook adapted to be displaced between an unlocked and a locked position, said window frame comprising a corresponding keeper to receive and retain said latch hook when said lever-type handle is in said locked position and when said operable sash is in said closed position.

17. The electrified window as claimed in claim 14 further comprising a lock for said operable sash, said lock comprising a lever-type handle connected to a latch hook adapted to be displaced between and unlocked and a locked position, said window frame comprising a corresponding keeper to receive and retain said latch hook when said lever-type handle is in said locked position and when said operable sash is in said closed position.

18. The electrified window as claimed in claim 16, further comprising a sash position detector, said sash position detector being adapted to detect a position of said operable sash, said position being one of said closed position and said open position, wherein said sash position detector is a switch being activated by said lock.

19. The electrified window as claimed in claim 17, further comprising a sash position detector, said sash position detector being adapted to detect a position of said operable sash, said position being one of said closed position and said open position, wherein said sash position detector is a switch being activated by said lock.

20. The electrified window as claimed in claim 14, further comprising a sash position detector, said sash position detector being adapted to detect a position of said operable sash, said position being one of said closed position and said open position.

21. The electrified window as claimed in claim 20 wherein said sash position detector is a push button provided on said window frame facing said opening side of said operable sash, said push button being depressed by said opening side when said operable side is in said closed position.

22. The electrified window as claimed in claim 14, wherein said electrically powered system operates with household voltage levels.

23. The electrified window as claimed in claim 14, wherein said electrical connector is a male-female connector having a male portion and a female portion adapted to receive said male portion for connection, one of said male portion and said female portion being provided on a side of said window frame facing said opening side of said operable sash and a complementary one of said male portion and said female portion being provided on said opening side of said operable sash, said male portion being fully received in said female portion when said sash is in said closed position, a plug being provided in said male portion and a socket provided in said female portion and wherein said plug and said socket are adapted to provide an electrical connection when said male portion is fully received in said female portion.

24. The electrified window as claimed in claim 14, wherein said electrically powered system is a heated window sash assembly adapted to radiate heat from said window sash when powered on, said change in condition being an increase in window temperature.

25. The electrified window as claimed in claim 14, wherein said window is one of a casement window, a single hung window, a double hung window, a single sliding window, a double sliding window, a bay window, a bow window, a skylight, an awning window and a patio door.

26. The electrified window as claimed in claim 14, wherein said sash is operable by sliding.

27. The electrified window as claimed in claim 14, wherein said sash is operable by pivoting about an axis.

28. The electrified window as claimed in claim 14, further comprising a fixed sash.

29. The electrified window as claimed in claim 28, wherein said electrically powered system has a fixed sash sub-system for producing said change in a fixed sash condition of said fixed sash upon powering on by electricity and an operable sash sub-system for producing said change in a operable sash condition of said operable sash upon powering on by electricity, said electrical connector allowing electricity to electrify said operable sash sub-system when said operable sash is in said closed position.

30. The electrified window as claimed in claim 29, wherein said fixed sash sub-system is electrified independently from said operable sash sub-system.
